(19) United States
(12) Patent Application Publication
(10) Pub. No.: US 2006/0120528 A1
(43) Pub. Date: Jun. 8, 2006

(54) Method of constructing hyperelliptic curves suitable for cryptographic purposes and cryptographic apparatus using such a method

(75) Inventor: Annegret Weng, Hanau (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILLIPS ELECTRONICS N.C.

(21) Appl. No.: 10/541,893

(22) PCT Filed: Dec. 19, 2003
(86) PCT No.: PCT/IB03/06267

§ 371 Date: Jul. 8, 2005

(30) Foreign Application Priority Data
Jan. 10, 2003 (EP) 03100032.6

(51) Int. Cl. H04K 1/00

(52) U.S. Cl. 380/255

(57) ABSTRACT

To provide a method for determining secure hyperelliptic curves quickly, it is proposed that suitable hyperelliptic curves be constructed using the complex multiplication method. The inventive method generates hyperelliptic curves, suitable for cryptographic applications, of genus 2 over finite fields having large characteristics. The invention further provides a cryptographic apparatus making use of a method as described beforehand can advantageously be used for encrypting and decrypting of messages for the secure exchange of information over public networks between senders and receivers. With such a cryptographic apparatus, messages and documents due for exchange can be encrypted fast and easily in an authentication procedure for the senders and receivers.

In many cases, the secure exchange of information over public networks between senders and receivers requires the messages and documents due for exchange to be encrypted and therefore is in need of an authentication procedure for the senders and receivers.

An encrypting or cryptographic method that is encountered with particular frequency is what is termed “asymmetric” encryption, which is also known as the “public key” method. This method allows the receiver of a message to transmit a key over the public network to the sender, i.e. in such a way that it is, in principle, accessible to any third party. This key is the “public key”. The sender then encrypts the message using this key. Where the power of the public key method lies is in that fact that a message that has been encrypted in this way cannot be decrypted again with a knowledge of the public key alone. Only the generator of the public key, i.e. the receiver, can decrypt the message encrypted with its public key. There are a number of variant types of asymmetric encryption of this kind. The most widely familiar example of an asymmetric method is undoubtedly the RSA method.

A subgroup of public key methods includes the step of exponentiating a very large natural number or integer modulo of another large natural number, the public key. The security of this group of methods is based on the impossibility in practice of calculating discrete logarithms in order to obtain the secret exponent in this way. Examples of methods of encryption and authentication based on the discrete logarithm problem are those known by the names Diffie-Hellman encryption, El-Gamal encryption, DSS signatures and Schnorr's method.

The finite Abelian group on which the discrete logarithm is based can be selected in various ways. One possible choice is the group of F_{q}-rational elements of the divisor class group of zero (0) degree of a hyperelliptic curve that is defmed over a finite field F_{q}. For this group, which is also referred to as the F_{q}-rational point group of the Jacobi variety of the hyperelliptic curve, there exists a compact representation of the elements of the group and an efficient adding algorithm. Further details of the representation and use of this group are discussed in, for example, N. Koblitz “Algebraic Aspects of Cryptology”, Springer Verlag, 1998.

One problem with this choice is however the determination of a suitable hyperelliptic curve, To ensure that the discrete logarithm problem cannot be solved in practice, the divisor class group of this curve should include a very large prime factor, because the run time of algorithms to solve the logarithm problem depends on the square root of this prime factor. If the performance of today's computer systems is taken as a basis, the prime factor should be at least 2¹⁶⁰ bits long. However, to ensure that the system is efficient, the parameters of the system, such as the keys for example, should not be too large.

Hyperelliptic curves that meet these conditions are curves whose zero degree divisor class group is of a prime or almost prime group order. To determine curves of this kind, it is, in principle, possible to select the coefficients of the curve randomly from the finite field Fₚ. If the resulting curve is non-singular, the number of elements of the divisor class group can then be determined. However, it has not so far been possible to find an algorithm that will determine this number, i.e. the order of the divisor class group, for a randomly selected hyperelliptic curve over a field having a large characteristic (p>2⁸⁰ for genus 2 curves). In addition, only a fraction of hyperelliptic curves have a divisor class group of prime or almost prime order and because of this, even if there were such an algorithm, there would still be the problem of having to test a large number of curves before a curve that was secure in the sense defined above could be determined. These tests detract from the speed of the selection process.

It is therefore an object of the invention to define a method for the fast determination of secure hyperelliptic curves. It is further an object of the present invention to provide a cryptographic apparatus for carrying out such a fast determination of secure hyperelliptic curves.

For the purposes of the present invention, this object is achieved by constructing suitable hyperelliptic curves by using the method of complex multiplication. The inventive method generates, for cryptographic applications, suitable genus 2 hyperelliptic curves over finite fields having large characteristics.

A hyperelliptic curve of genus g over a field F_{q} (or Fₚ) having a characteristic not equal to 2 can be defined as a non-singular curve of the form
y2=f(x),
where f(x) is a normalized polynomial of degree 2 g+1.

The complex multiplication method, referred to below as the CM method, is known per se and has been used by Atkin for example to construct elliptic curves. For details of this known application of the CM theory, reference may made be made to: A. O. L Atkin, F. Morain, Elliptic curves and primality proving, Math. Comp. 61: 29-68, 1993. The known CM method makes it possible to determine, for a given imaginary quadratic order O and a prime number p, an elliptic curve E defined over Fₚ whose endomorphism ring is isomorphic to O. The complexity of the CM method and hence the computing work it involves is determined in this case by the class number h(O) and the discriminant of the order O. In dissertations by A. -M. Spallek [IEM, 1994, preprint no. 18] and the present inventor A. Weng [IEM, 2002, preprint no. 11], the application of the CM method was extended to the construction of hyperelliptic curves of genus 2 and class number 1 (Spallek) and to hyperelliptic curves of genus 2 and a class number of up to 10 and to special cases of hyperelliptic curves of genus 3 and above (Weng).

In particular, in the method according to the invention a representant system of all isomorphism classes of simple principally polarized Abelian varieties is determined. The counting of the isomorphism classes is simplified in this case because there is no need to check whether the fundamental unit is a relative norm of a unit in the CM field K.

Also the period matrices can be converted into equivalent Siegel-reduced matrices and a faster convergence of the theta nulls obtained in this way.

In a further preferred embodiment, the hyperelliptic curve over the field C of complex numbers is determined from six of ten theta nulls that are calculated.

Also, in a preferred variant of the method according to the invention, a plurality, and in particular more than a hundred or more than a thousand even, of possible CM fields are determined and the class polynomials belonging to the CM fields are calculated and the two are stored as a data set prior to use of the method for determining a secure hyperelliptic curve.

In a variant of the method according to the invention, the range of CM fields that are possible is reduced by a test. It can be ensured in this way that an exact prime number can be obtained for the group order.

In the method according to the invention, the prime number p on which the finite field Fₚ is based is selected in such a way that the minimum polynomial of the CM field K over Fₚ decomposes into four different linear factors.

In another variant, the finite field F_{q} on which the curve is based is not prime.

A cryptographic apparatus making use of a method as described beforehand can advantageously be used for encrypting and decrypting of messages for the secure exchange of information over public networks between senders and receivers. With such a cryptographic apparatus, messages and documents due for exchange can be encrypted fast and easily in an authentication procedure for the senders and receivers.

These and other aspects of the invention are apparent from and will be elucidated with reference to the embodiments described hereinafter.

In the drawings:

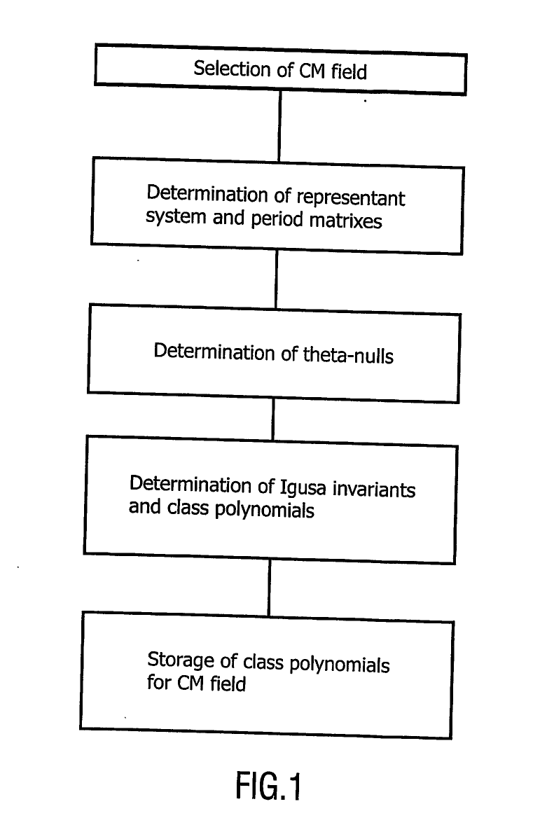

FIG. 1 shows a first sub-step according to the invention for determining a CM field and the associated class polynomials.

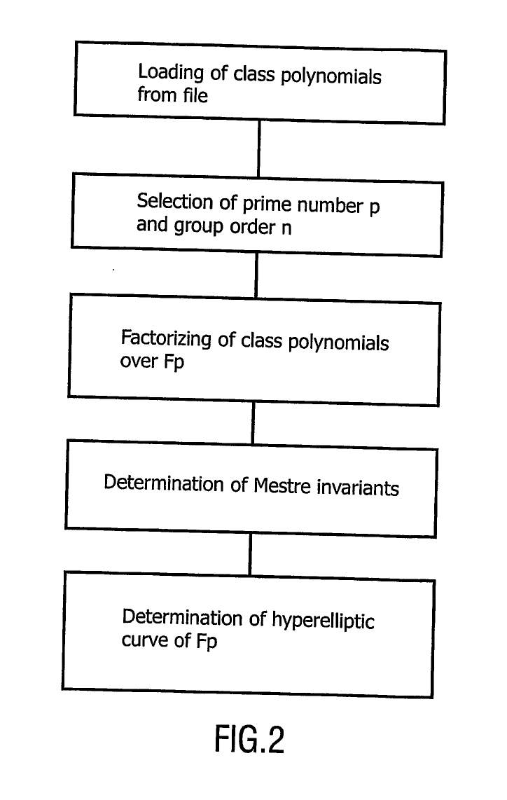

FIG. 2 shows a second sub-step according to the invention for determining a curve suitable for cryptographic purposes.

In what follows, steps of the method according to the invention will be described in detail. The method includes two sub-steps. The first sub-step relates to the determination of a CM field K, of a prime number p suitable for defining the field Fₚ, and of a suitable group order n.

A suitable CM field K is first determined by a total imaginary quadratic expansion of a totally real number field K_{O} having a class number h_{KO}=1. A CM field of this kind may for example be given by the set K=Q(i(a+bd)^{1/2})^{1/2}), where a, b and d are integers.

The prime number p is selected in such a way that the following three conditions are met:

1. There is a number w in O_{K} such that w\overline{w}=p, where O_{K} is the maximum order of K and \overline{w} is the conjugate complex element of w (here and in what follows, the underlining indicates the conjugate complex element of the item underlined).

2. Either n₁=Π(1−wᵢ) or N₂=Π(1+wᵢ) is almost prime, where the product Π covers all the conjugates wᵢ of w in K.

3. One of the orders nᵢ (i=1,2) is of the form kq, where k is a small number and q is a prime number that meets the condition that the order of p in F_{q} is high.

The selection of p can be simplified in this case by selecting a random number η from O_{K} and checking whether the conjugate complex element of the product η\overline{η} is a prime number. If it is, n₁ or n₂ can be checked for compliance with condition 2. The number η should be selected in this case in such a way that it is ensured that its relative norm is a member of the set Z of integers.

Alternatively, a random number p can be selected from Z and the minimum polynomials in Z[x] can be determined for all the solutions of the absolute norm equation N/_{K/Q}(w)=p². From these polynomials, the ones that are irreducible and have zero points of an absolute value p^{1/2} are selected. These minimum polynomials are then analyzed at the point x=1. This gives a set S of possible group orders nᵢ. This set has at most four different members. These values nᵢ can then be tested for compliance with conditions 1 and 2 above.

For the subsequent second sub-step, it can be assumed that a CM field K, a prime number p and a group order n have been determined that meet conditions 1-3 in the first sub-step. In this second sub-step, a hyperelliptic curve over Fₚ is constructed that has a divisor class group of order n.

In so doing, advantage is taken of the fact that, in the case of hyperelliptic curves of genus 2, the Jacobi varieties of these curves are exactly the principally polarized Abelian varieties of dimension 2. Also, it is possible, using known methods, to find a representant system for all isomorphism classes of simple principally polarized Abelian varieties of the field C of complex numbers that have complex multiplication by O_{K}. It is also known in principle for a period matrix Ω of these varieties to be determined from the set H₂, where H₂={M from Gl₂(C), M^{t}=M, with Im M being positively definite} is the Siegel upper half-plane of dimension 2. The matrix is thus symmetrical and has a positively defined imaginary part.

Let the following be taken as an example:
K₀=Q(6^{1/2}) where O_{K0}=Z+ωZ, ω=6^{1/2}
K=Q(i(3+6^{1/2})/^{1/2})
p=13970339430705346738100941, and
n=195170383809059575030928920714011851354971964238376.

η is taken as equal to i(3+)^{1/2}). The fundamental unit ε₀ of Q(6^{1/2}) has a positive norm in this case. A representant system of the ideal class group that is relatively complete with respect to the real quadratic subfield O_{K0} can be represented as:
I_{K}={A₁=O_{K}=O_{K0}+ηO_{K0}, A₂=(1−6^{1/2})O_{K0}+(−1+η)O_{K0}}.

From the general representation of A1 and A2:
Ai=αO_{K0}+βO_{K0},
τᵢ=α/62 is calculated, where, taking the above example,
τ₁=0.4283729905961322011i
τ₂=0.2247448713915890490+0.5246476232752903178i.

An embedment σ of K in the field of complex numbers C is given by
σ(i(3+2^{1/2})^{1/2})=−i(3−2^{1/2})^{1/2} and
ρas the conjugate complex element thereto. A representant system of all the isomorphism classes of simple principally polarized Abelian varieties that have multiplication by O_{K} is then given by the set of tuples
{(τ₁, τ₁^{σ}) , (ε₀τ₂, (ε₀τ₁)^{σ}), (τ₁,τ₁^{ρσ}), (ε₀τ₁, (ε₀τ₁)^{ρσ})}.

The associated period matrix for a tuple (s₁, S₂) is

$${Ω}_{s 1 , s 2} = \frac{1}{ω - {ω}^{σ}} ( \begin{matrix}{ω}^{2} {s}_{1} - {ω}^{σ 2} {s}_{2} & ω {s}_{1} - {ω}^{σ} {s}_{2} \\ ω {s}_{1} - {ω}^{σ} {s}_{2} & {s}_{1} - {s}_{2}\end{matrix} )$$

By the following procedure, a count is obtained of the isomorphism classes, if the field K=Q(i(a+bd^{1/2})^{1/2}) is a CM field, ε0 is the fundamental unit, σis the conjugation
σ(i(a+bd^{1/2})^{1/2})=−i(a−bd^{1/2})^{1/2}
and σ is the complex conjugation. For a representant Aᵢ=αᵢO_{K0}+βᵢOₖ₀, τᵢ=αᵢ/βᵢ is obtained where Im(τᵢ)>0. With {τ₁, . . . , τₖ, . . . , Tₕₖ} and k≦\overline{h} as a class group, it is the case that Im τᵢ^{σ}>0 for i≦\overline{k} and Im τᵢ^{σ}<0 for i>k. The following rules allow a suitable set S of simple principally polarized Abelian varieties that are complexly multipliable with O_{K} to be obtained:

If K is Galoisian, then S:={(τᵢ, τᵢ^{σ}), 1≦\overline{i}≦\overline{h}}.

If K is non-normal and if N(ε₀)=1 then k:=h/2; S:={(τᵢ,τ₁^{σ}), (ε₀τᵢ,(ε₀τᵢ)^{ρσ}), 1≦\overline{i}≦\overline{h}}. and if K is non-normal but N(ε₀)=−1 the definition obtained is as follows:
S:={(τᵢτᵢ^{σ}), (ε₀τᵢ, (ε₀τᵢ)^{ρσ}), 1≦\overline{i}≦\overline{h}}.

For each matrix of the period matrix Ωᵢ i determined above where i=1, . . . , 4, the absolute invariants jₖ⁽ⁱ⁾ are then calculated with k=1, 2, 3. For this purpose, the even theta-nulls are first calculated for each matrix Ωᵢ and with the help of the theta-null, that curve over C is determined whose Jacobi variety corresponds to the period matrix Ω. The class polynomials of the curve are calculated from the absolute invariants.

The even theta-nulls of a period matrix Ωi are given by

$$θ [ \begin{matrix}δ \\ ɛ\end{matrix} ] ( {Ω}_{i} ) = {\sum }_{n from {Z}^{g}} exp ( π i ( {( n + 1 / 2 δ )}^{t} {Ω}_{i} ( n + 1 / 2 δ ) + 2 ( n + 1 / 2 δ ) {( z + 1 / 2 ɛ )}^{t} ) \text{)} ,$$

with δ, ε from the set {0,1)}^{g}, δ^{t}ε=0 mod 2.

For genus 2 curves, this function gives exactly ten theta-nulls. The quality of the approximation should be selected such that the approximation of the class polynomials calculated subsequently is adequate for a smooth number n to be in Z[1/n][X]. In the example described, seventy decimal places is enough.

The convergence of the equation with the theta-nulls can be improved if Siegel-reduced matrices Ω′ are inserted in the function rather than the matrices Ωᵢ from H₂. A matrix Ω′=X+iY from H₂ where X=(xₖ₁) with subscripts k,1={1,2} is Siegel-reduced if the following are true:
1. 1/2≦xₖ₁≦−1/2
2. Y is Minkowski-reduced
3.

$$\vert det ( CZ + D ) \vert \geq 1 for all ( \begin{matrix}A & B \\ C & D\end{matrix} ) ∈ Sp ( 4 , Z ) .$$

By means of the theta-nulls, a model of the curve over C that is being looked for can be determined. The Rosenhain model is a model of this kind
y2=x(x−1)II (x−λᵢ),
where the subscript i extends from 1 to 2 g−1, i.e. for curves of genera 2 to 3. The Rosenhain model allows the λᵢ values to be calculated from the theta-nulls. The following are the case in the example below:
λ₁=3.7761476679542305243215+1.0919141042403378864850i
λ₂=\overline{λ₁}
λ₃=−0.5826628324044744213034.

From the 10 even theta-nulls, the so-called absolute Igusa invariants j₁, j₂, j₃ are also obtained as known functions.

Both the λᵢ's of the Rosenhain model and the Igusa invariants can however also be determined simply from six theta-nulls:

$${α}_{1} = θ [ \begin{matrix}( 00 ) \\ ( 10 )\end{matrix} ] {α}_{2} = θ [ \begin{matrix}( 01 ) \\ ( 10 )\end{matrix} ] {α}_{3} = θ [ \begin{matrix}( 11 ) \\ ( 10 )\end{matrix} ]$$

$${α}_{4} = θ [ \begin{matrix}( 00 ) \\ ( 10 )\end{matrix} ] {α}_{5} = θ [ \begin{matrix}( 01 ) \\ ( 10 )\end{matrix} ] {α}_{6} = θ [ \begin{matrix}( 11 ) \\ ( 10 )\end{matrix} ]$$

The λᵢ's of the model f(x)=x(x−1) (x−λ₃) (x−λ₃) (x−λ₅) are given by:
λ₃=α₁²α₂²(α₃²α₄²)⁻¹
λ₃=α₅²α₂²(α₃²α₆²)⁻¹
λ₃=α₅²α₁²(α₄²α₆²)⁻¹
and the (non-absolute) Igusa invariants are defined by
I₂=−120A′, I₄=−720(A′)²+6750 B′,
I₆=8640(A′)³−108000A′B′+202500C′.
where
A′=(f, f)₆, B′=(i, i)₄., C′=(i, Δ)₆
and
i=(f, f)₄, Δ=(i, if)₂
where the term (gh)ₖ represents the overlaying of two binary forms g and h of degrees n and m, of the form

$${( gh )}_{k} = \frac{( m - k ) ! ( n - k ) !}{m ! n !} ( \frac{δ g}{δ x} \frac{δ h}{δ z} - \frac{δ g}{δ z} \frac{δ h}{δ x} ) .$$

The absolute invariants can then be obtained from the Igusa invariants:
j₁=I₂I₄²/Δ, j₂=I₂³I₄/Δ, j₃=I₄I₆/Δ.

The calculation of the Igusa invariants may be further speeded up by sorting the group I_{K} of ideal classes into pairs of ideal classes and their inverses. Because it is true in the case of the field K₀ of class number 1 that the inverse ideal classes are equal to the conjugate complex ideal classes, only one simple principally polarized Abelian variety need be calculated for each pair of conjugate complex ideal classes that is found:

If (τ₁,τ₁¹⁰⁴) is the principally polarized Abelian variety belonging to the ideal Aᵢ and the CM type (K, ψ), then (−\overline{τ}ᵢ,−\overline{τ}ᵢ^{ψ}) is the principally polarized Abelian variety of the same CM type, belonging to \overline{A}ᵢ. If in addition jᵢ is the Igusa invariant of (τᵢ,τᵢ^{ψ}), then the corresponding Igusa invariant of (−\overline{τ}ᵢ,−\overline{τ}ᵢ^{ψ}) is equal to j_{\overline{i}}. Hence, only one Igusa invariant needs to be determined for each pair of inverses of conjugate complex ideal classes. Consequently, the amount of computing work required for this step is almost halved.

The class polynomials Hₖ can be represented as functions of the Igusa invariants jₖ, k=1, . . . , 3:
Hₖ(X):=II(X−jₖ⁽ⁱ⁾), where i=1, . . . , 4).

The polynomials are members of the corpus of rational polynomials Q[x]. By applying the method of infinite continued fractions followed by multiplication, Kₖ(X) can be converted into an integer polynomial Hₖ(X)^{#}. What is obtained in the example for

$${H}_{1} ( X ) = Π ( X - {j}_{1}^{( i )} ) is - 46989351758.431801106481797 {X}^{3} - 45970146813147129.294447100607881 {X}^{2} + 10924459381549069304009.28898299296496140 X + 62662202899453662501195273.54688887371081210299 .$$

If the accuracy is selected to be sufficiently high, the least common multiple of the denominators of the coefficients is found with the continued fraction algorithm. In the present example this is 11⁴. This gives the integer polynomial:

$${{H}_{k} ( X )}^{\#} = 14641 {X}^{4} - 687971099095200 {X}^{3} - 673048919491287120000 {X}^{2} - 159945009805259923680000000 X + 917437312650901072680000000000.$$

The class polynomials of the form Hₖ(X) over Q[x] and of the form Hₖ(X)^{#} over the field of integer polynomials Z[x] depend only on the CM field K that is selected. The basic prime number field Fₚ for the hyperelliptic curve may however still vary even after the CM field K has been selected. Ii is therefore advantageous for a large number, hundreds or thousands in practice, of suitable CM fields and the associated class polynomials to be calculated in advance and stored in some suitable manner. If after this step it is necessary for a hyperelliptic curve to be generated for the application of encryption, recourse may be had to a randomly selected CM field, or in other words to randomly selected class polynomials, from the file held in store, and a suitable prime number p and group order n may be determined by the criteria listed in the first sub-step. After that, the following steps may be performed immediately to determine the hyperelliptic curve over Fₚ without the class polynomials having to be re-determined.

For the implementation of a cryptographic protocol, it may also be advantageous for the operation to be confined to group orders that are exactly prime.

For this purpose, it is proposed that the selection of the CM fields be limited and that the only CM fields K used be ones for which the minimum polynomial K/Q modulo 2 has two different factors or is irreducible.

So, for the following steps for calculating the hyperelliptic curve over Fₚ, it is assumed that the CM field K has been selected and the class polynomials Hₖ(X)¹⁹⁰ have either been calculated by performing the steps described above or have been taken from a file that was calculated in advance.

The next step is to calculate the curve. For this purpose, the following steps are performed for each tripel (a₁, a₂, a₃) from (Fₚ)³ with Hₖ(X)^{#} (ak)=0 mod p:

Set j₁:=a₁, j₂:=a₂ and j₃:=a₃. Then calculate the Mestre invariants Aᵢⱼ and Hᵢⱼₖ from jᵢ. Under the known Mestre procedure for finite fields, as described for example in J. -F. Mestre, “Constructions des courbes de genre 2 à partir de leur modules”, Progr. Math. Birkhäuser, 94: 313-344, 1991, the Mestre invariants are coefficients of a quadric of the form
ΣAᵢⱼxᵢxⱼ
and of a cubic of the form ΣHᵢⱼₖxᵢxⱼxₖ, where the summing extends through subscripts i, j, k from 1 to 3.

By setting parameters for the quadric by taking polynomials f₁(t), f₂(t), f₃(t) and inserting them in the cubic
ΣHᵢⱼₖfᵢ(t), fⱼ(t), fₖ(t)
a model
y²=f(t)
of the hyperelliptic curve over Fₚ can be obtained. The degree of the polynomial f(t) (generally 6) can then by reduced by one to 5 by projective transformation if f(t) has a zero point in Fₚ. Then check whether the divisor class group of the curve is of order n by selecting a random divisor D and forming the product nD.

The resulting curve in the case of the example given is

$${y}^{2} = {x}^{5} + 4464505615838997835224600 {x}^{4} + 11942994115339229240469614 {x}^{3} + 1108584063993749350888007 {x}^{2} + 11457344736666435422023499 x + 2901066642986978406675671.$$

and is defined over the field Fₚ where p=13970339430705346738100941 and n=195170383809059575030928920714011851354971964238376 are equal to the above mentioned values. The value of n is 152 times a prime number.

The Mestre algorithm can be speeded up selecting a suitable prime number p. Prerequisites for this are that the CM field K is non-normal and p is a prime number belonging to the set of integers Z that is completely decomposed in K or, which is equivalent to this, the minimum polynomial of K in Fₚ can be decomposed into four different linear factors. Under these conditions, the number of linear factors modulo p for each class polynomial is halved, provided the above equation w\overline{w}=p has, except for the sign and the conjugate complex element, only one solution w from the set O_{K}. This halving of the linear factors speeds up the application of the Mestre algorithm by a factor of 8.

To allow this advantage to be exploited, a check is made to see whether a primary number p determined in the first sub-step above decomposes the minimum polynomial of K in Fₚ into four different linear factors. This can be done by direct calculation. If however, as described above, p was selected by analysis at the point x=1 of mhinum polynomials in Z[x] that are irreducible and have zero points at the absolute value p^{(1/2)}, the prime numbers found are alreadypresorted. After this, the prime numbers can be confined to ones that permit only two different group orders.

If the CM field is cyclic and the exponent of the ideal class group is larger than 2, then the prime numbers that are advantageous in this sense are of positive density. In particular there are an infinite number of such prime numbers.

The method described for generating a hyperelliptic curve suitable for cryptographic purposes may be expanded to cover non-prime finite fields F_{q}. The number q:=p^{f} is defined as a power of a primary number p in this case. The exponent f is a natural number and is referred to as a degree of expansion. It may also be assumed that the curve cannot be defined over a subfield of F_{q}.

In the event of the CM field K being Galoisian, p should be selected such that p=A\overline{A} in K/K₀.

If f is selected to be a minimum under the condition that A^{f}=(w), w being an element from O_{K},

is a main ideal, then there is a square root of the class polynomials over F_{q}. Hyperelliptic curves over F_{q} can be constructed as detailed above from these roots by means of the Mestre algorithm. The order of these curves is given by
n=Π(1−wᵢ) or Π(1+wᵢ)
where the subscript i=1, . . . , 4 and wᵢ is the conjugate complex element of w.

In the event of the CM field being non-Galoisian and non-normal, the prime number p should be selected such that the prime ideal (p) decomposes into three ideals:
(p)=p₁\overline{p₂}p₂.

There is then an ideal A, which means that
A=p₁p₂²
and f is again selected to be a minimum with
A^{f}=(w), with w being an element from O_{K}.

Under these conditions, hyperelliptic curves over the non-prime finite fields F_{q}, where q=p^{2f}, can be constructed as detailed above by means of the Mestre algorithm. The group order can be calculated as in the case of a Galoisian field K.

As an example, a curve will be constructed over a field of the degree of expansion f=2 hₖ=10, starting from a CM field K having a class number hₖ=5. What will be used as a prime number is p=911, whose ideal (p) over the field K decomposes into three prime ideals. For ideal A=p₁p₂², f=5 is the smallest exponent. The main ideal is therefore A^{f}.

The elements in F_{q} with q=911¹⁰ can be stated by polynomials of degree 9. The modulo p irreducible class polynomials are
H₁(X)=701X¹⁰+401X⁹+322X⁸+712X⁷+125X⁶+774X⁵+513X⁴+869X³+474X²+49X+680 mod p
H₂(X)=186X¹⁰+895X⁹⁺⁴⁵³X⁸+86X⁷+180X⁶+47X⁵+811X⁴+339X³+887X²+296X+371 mod p
H₃(X)=75X¹⁰+280X⁹+616X⁸+737X⁷+511X⁶+179X⁵+623X⁴+533X³+616X²+697X+700 mod p

Two possible group orders are obtained:
n₁=155012792308846128138632814006095268154658315370266774539376
n₂=155012792308846046374979954330693046736810307187589966188400

The associated curve y²=f(x) is

$$f ( x ) = x 5 + [ 9 \; 703 \; 722 \; 261 \; 507 \; 119 \; 322 \; 684 \; 741 ] {x}^{4} + [ 715 \; 508 \; 396 \; 153 \; 661 \; 164 \; 513 \; 167 \; 892 \; 156 ] {x}^{3} + [ 548 \; 810 \; 311 \; 54 \; 483 \; 636 \; 130 \; 899 \; 845 \; 101 ] {x}^{2} + [ 550 \; 294 \; 663 \; 157 \; 288 \; 697 \; 710 \; 60 \; 475 \; 608 ] x + [ 301 \; 385 \; 355 \; 533 \; 347 \; 763 \; 659 \; 163 \; 720 \; 665 ] ,$$

use having been made of the abbreviating notation
a₀a₁z+a₂z²+a₃z³+ . . . +a₈z⁸+a₉z⁹=[a₀ a₁ a₂ a₃ . . . a₈ a₉].

The group order is n₂=400 r, where r is a prime number having 57 decimal places.

1. A method of determining a hyperelliptic curve suitable for cryptographic purposes, comprising the steps of:
selecting a CM field K,
determining a representant system of all isomorphism classes of simple principally polarized Abelian varieties having complex multiplication by the maximum order in K,
determining period matrices associated with the representant system,
determining theta-nulls,
determining class polynomials for the CM field over a finite field F_{q},
determining a hyperelliptic curve over the finite field F_{q} and
specifying the group order n of the divisor class group of the hyperelliptic curve.

2. A method as claimed in claim 1, wherein the hyperelliptic curve is of genus 2.

3. A method as claimed in claim 1, wherein Igusa invariants are determined from the theta-nulls.

4. A method as claimed in claim 3, wherein the Igusa invariants are used to determine the class polynomials.

5. A method as claimed in claim 1, wherein Mestre invariants are determined from the theta-nulls.

6. A method as claimed in claim 5, wherein the Mestre method is used to generate the hyperelliptic curve over F_{q}.

7. A method as claimed in claim 1, wherein a plurality of suitable CM fields K and the associated class polynomials are stored in accessible form and a CM field is selected from the plurality held in store to determine the hyperelliptic curve.

8. A method as claimed in claim 1, wherein the period matrices are used in a Siegel-reduced form.

9. A method as claimed in claim 1, wherein only six theta-nulls are determined.

10. A method as claimed in claim 1, wherein, to determine the representant system, a test is not made to see whether the fundamental unit of the real subfield of the Cm field K is the norm of a unit of the CM field.

11. A method as claimed in claim 1, wherein, to determine the representant system, a set of ideal classes is determined.

12. A method as claimed in claim 11, wherein pairs of mutually inverse ideal classes are identified and Igusa invariants are determined from the theta-nulls only once for each pair.

13. A method as claimed claim 1, wherein q is a prime number p.

14. A method as claimed in claim 13, wherein the prime number p is selected such that each class polynomial has no more than hₖ linear factors, where hₖ is the class number of the CM field K.

15. A method as claimed in claim 1, wherein the CM field is selected such that the group order n of the divisor class group of the hyperelliptic curve is exactly prime.

16. A method as claimed in claim 1, wherein q is the power of a prime number p.

17. A cryptographic method, wherein keys for encrypting data are determined from the group of F_{q}-rational numbers of a hyperelliptic curve that was generated by a method as claimed in claim 1.

18. Cryptographic apparatus using a method according to claim 1.

19. Sender for sending a message, comprising a cryptographic apparatus for encrypting of messages according to claim 18.

20. Receiver for receiving a message, comprising a cryptographic apparatus for decrypting of messages according to claim 18.
